(19) United States
(12) Patent Application Publication
(10) Pub. No.: US 2024/0428616 A1
(43) Pub. Date: Dec. 26, 2024

(54) USER TERMINAL, PROCESSING EXECUTION APPARATUS, AUTHENTICATION SYSTEM, AUTHENTICATION ASSISTANCE METHOD, PROCESSING EXECUTION METHOD, AND COMPUTER READABLE MEDIUM

(71) Applicant: NEC Corporation, Minato-ku, Tokyo (JP)

(72) Inventor: Hajime Suzuki, Tokyo (JP)

(73) Assignee: NEC Corporation, Minato-ku, Tokyo (JP)

(21) Appl. No.: 18/700,326

(22) PCT Filed: Nov. 15, 2021
(86) PCT No.: PCT/JP2021/041852

§ 371 Date: Apr. 11, 2024

(51) Int. Cl. G06V 40/16; H04W 12/06

(52) U.S. Cl. CPC G06V 40/172; G06V 40/168; H04W 12/06

(57) ABSTRACT

A user terminal includes: an imaging unit that captures an information code including predetermined activation information (e.g., information for activating an authentication assistance function program); an activation unit that activates an authentication assistance function program using the activation information included in the captured information code; an acquisition unit that acquires an image including a face of a user captured by the imaging unit according to the activation of the authentication assistance function program; and an output unit that outputs biometric information of the user based on the image for biometric authentication.

### TECHNICAL FIELD

The present invention relates to a user terminal, a processing execution apparatus, an authentication system, an authentication assistance method, a processing execution method, and a program, and more particularly, to a user terminal, a processing execution apparatus, an authentication system, an authentication assistance method, a processing execution method, and a program capable of executing processing using biometric authentication.

### BACKGROUND ART

In recent years, payment processing and member certification using face authentication in a store have been widely used. Patent Literature 1 discloses a technique for performing authentication using face image data. A transaction processing apparatus according to Patent Literature 1 reads face image data from a card, extracts a feature point as feature point data from the face image data, and transmits the feature point data to a host computer. Then, the host computer performs authentication based on the feature point data.

### CITATION LIST

### Patent Literature

Patent Literature 1: Japanese Unexamined Patent Application Publication No. 2003-256746

### SUMMARY OF INVENTION

### Technical Problem

From the viewpoint of reliability of identity confirmation, for biometric authentication such as face authentication, it is preferable to image a face on the spot and extract feature point data of the face from the captured image. However, it is required to install a camera for reading biometric information at the time of performing biometric authentication at each point of a facility such as a store, which has a problem that introduction costs are high. Note that, in the technology according to Patent Literature 1, since face image data stored in advance in a card is used, it is not possible to eliminate concern about impersonation using a card of another person.

In view of the above-described problem, an object of the present disclosure is to provide a user terminal, a processing execution apparatus, an authentication system, an authentication assistance method, a processing execution method, and a program for suppressing biometric authentication introduction costs while ensuring reliability of identity authentication.

### Solution to Problem

According to a first aspect of the present disclosure, a user terminal includes:
an imaging means for capturing an information code including predetermined activation information;
an activation means for activating an authentication assistance function using the activation information included in the captured information code;
an acquisition means for acquiring an image including a face of a user captured by the imaging means according to the activation of the authentication assistance function; and
an output means for outputting biometric information of the user based on the image for biometric authentication.

According to a second aspect of the present disclosure, a processing execution apparatus includes:
an acquisition means for acquiring, from a user terminal possessed by a user, biometric information based on an image including a face of the user captured by the user terminal according to an authentication assistance function of the user terminal activated based on predetermined activation information included in an information code captured by the user terminal;
an authentication control means for controlling biometric authentication for the user when the biometric information is acquired; and
an execution means for executing predetermined processing when the biometric authentication has succeeded.

According to a third aspect of the present disclosure, an authentication system includes:
a user terminal possessed by a user; and
a processing execution apparatus configured to execute predetermined processing, in which
the user terminal includes:
an imaging means for capturing an information code including predetermined activation information;
an activation means for activating an authentication assistance function using the activation information included in the captured information code;
an acquisition means for acquiring an image including a face of the user captured by the imaging means according to the activation of the authentication assistance function; and
an output means for outputting biometric information of the user based on the image for biometric authentication, and
the processing execution apparatus includes:
an acquisition means for acquiring the biometric information from the user terminal;
an authentication control means for controlling biometric authentication for the user when the biometric information is acquired; and
an execution means for executing predetermined processing when the biometric authentication has succeeded.

According to a fourth aspect of the present disclosure, an authentication assistance method includes:
by a computer including an imaging device,
capturing an information code including predetermined activation information by the imaging device;
activating an authentication assistance function using the activation information included in the captured information code;
acquiring an image including a face of a user captured by the imaging device according to the activation of the authentication assistance function; and
outputting biometric information of the user based on the image for biometric authentication.

According to a fifth aspect of the present disclosure, a non-transitory computer readable medium stores a program for causing a computer including an imaging device to execute:
imaging processing of capturing an information code including predetermined activation information by the imaging device;
activation processing of activating an authentication assistance function using the activation information included in the captured information code;
acquisition processing of acquiring an image including a face of a user captured by the imaging device according to the activation of the authentication assistance function; and
output processing of outputting biometric information of the user based on the image for biometric authentication.

According to a sixth aspect of the present disclosure, a processing execution method includes:
by a computer:
acquiring, from a user terminal possessed by a user, biometric information based on an image including a face of the user captured by the user terminal according to an authentication assistance function of the user terminal activated based on predetermined activation information included in an information code captured by the user terminal;
controlling biometric authentication for the user when the biometric information is acquired; and
executing predetermined processing when the biometric authentication has succeeded.

According to a seventh aspect of the present disclosure, a non-transitory computer readable medium stores a program for causing a computer to execute:
acquisition processing of acquiring, from a user terminal possessed by a user, biometric information based on an image including a face of the user captured by the user terminal according to an authentication assistance function of the user terminal activated based on predetermined activation information included in an information code captured by the user terminal;
authentication control processing of controlling biometric authentication for the user when the biometric information is acquired; and
execution processing of executing predetermined processing when the biometric authentication has succeeded.

### Advantageous Effects of Invention

According to the present disclosure, it is possible to provide a user terminal, a processing execution apparatus, an authentication system, an authentication assistance method, a processing execution method, and a program for suppressing biometric authentication introduction costs while ensuring reliability of identity authentication.

### BRIEF DESCRIPTION OF DRAWINGS

FIG. 1 is a block diagram illustrating a configuration of a user terminal according to a first example embodiment.

FIG. 2 is a flowchart illustrating a flow of an authentication assistance method according to the first example embodiment.

FIG. 3 is a block diagram illustrating a configuration of a processing execution apparatus according to a second example embodiment.

FIG. 4 is a flowchart illustrating a flow of a processing execution method according to the second example embodiment.

FIG. 5 is a block diagram illustrating an overall configuration of an authentication system according to a third example embodiment.

FIG. 6 is a block diagram illustrating a configuration of a store management apparatus according to the third example embodiment.

FIG. 7 is a block diagram illustrating a configuration of an authentication apparatus according to the third example embodiment.

FIG. 8 is a flowchart illustrating a flow of face information registration processing performed by the authentication apparatus according to the third example embodiment.

FIG. 9 is a block diagram illustrating a configuration of a user terminal according to the third example embodiment.

FIG. 10 is a block diagram illustrating a configuration of a payment terminal according to the third example embodiment.

FIG. 11 is a sequence diagram illustrating a flow of payment processing according to the third example embodiment.

FIG. 12 is a flowchart illustrating a flow of face authentication processing performed by the authentication apparatus according to the third example embodiment.

FIG. 13 is a block diagram illustrating an overall configuration of an authentication system according to a fourth example embodiment.

FIG. 14 is a sequence diagram illustrating a flow of payment processing according to the fourth example embodiment.

FIG. 15 is a block diagram illustrating an overall configuration of an authentication system according to a fifth example embodiment.

FIG. 16 is a sequence diagram illustrating a flow of payment processing according to the fifth example embodiment.

### EXAMPLE EMBODIMENT

Hereinafter, example embodiments of the present disclosure will be described in detail with reference to the drawings. In the drawings, the same or corresponding elements are denoted by the same reference signs and redundant description will be omitted if necessary for clarity of description.

### First Example Embodiment

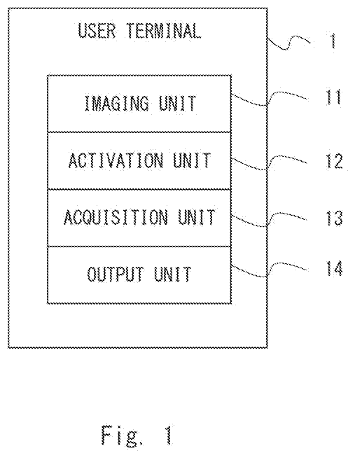

FIG. 1 is a block diagram illustrating a configuration of a user terminal 1 according to the first example embodiment. The user terminal 1 is an information terminal that can be carried by a user and is capable of wireless communication. In addition, the user terminal 1 includes an imaging device. The user terminal 1 includes an imaging unit 11, an activation unit 12, an acquisition unit 13, and an output unit 14. The imaging unit 11 captures an information code including predetermined activation information. Here, the information code is display information obtained by converting predetermined information into a code of a numerical value, a figure, or a combination thereof. The information code may be printed on a display plate or paper, or displayed on a display apparatus or the like. In addition, the activation information is information used to activate an authentication assistance function (not illustrated) of the user terminal 1. The authentication assistance function is a functional block that acquires and outputs biometric information based on a captured image of a user in order to cause an external authentication control apparatus (not illustrated) to perform a biometric authentication of the user. The authentication assistance function may be referred to as an authentication assistance unit for assisting a biometric authentication. The authentication assistance function is, for example, a computer program (application program) in which the processing is implemented. For example, in the user terminal 1, an application program related to the authentication assistance function is installed in advance. Therefore, the activation information may include at least information capable of specifying the authentication assistance function to be activated. Further, the activation information may include a character string of commands for executing an authentication assistance program related to the authentication assistance function. Note that the imaging unit 11 is an imaging device itself such as a camera built in the user terminal 1 or is a processing unit that controls the imaging device.

The activation unit 12 activates the authentication assistance function using the activation information included in the captured information code. The acquisition unit 13 acquires an image including the face of a user imaged by the imaging unit 11 according to the activation of the authentication assistance function. The output unit 14 outputs biometric information of the user based on the image for biometric authentication. The biometric information of the user based on the image is an image of a face area of the user in the image captured by the imaging unit 11 or facial feature information extracted from the image of the face area. In addition, the output unit 14 outputs the biometric information according to a predetermined communication method. For example, the output unit 14 may output the biometric information by short-range wireless communication. Alternatively, the output unit 14 may transmit the biometric information to a predetermined destination via a communication network. Note that the authentication assistance function unit described above may include the acquisition unit 13 and the output unit 14.

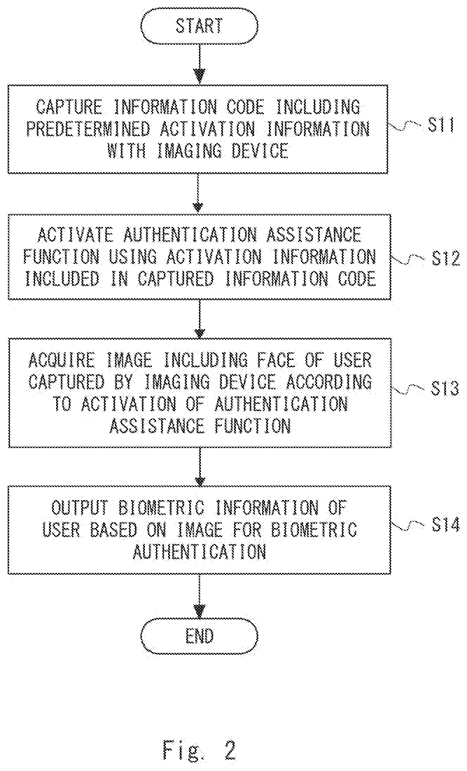

FIG. 2 is a flowchart illustrating a flow of an authentication assistance method according to the first example embodiment. First, the imaging unit 11 captures an information code including predetermined activation information with the imaging device included in the user terminal 1 (S11). Next, the activation unit 12 activates an authentication assistance function using the activation information included in the captured information code (S12). Here, when activated, the authentication assistance function controls the imaging unit 11 to capture an image of an area including the face of the user.

Then, the acquisition unit 13 acquires the image including the face of the user captured by the imaging device according to the activation of the authentication assistance function (S13). Then, the output unit 14 outputs biometric information of the user based on the image for biometric authentication (S14).

As described above, in the first example embodiment, the user terminal 1 captures an information code displayed on the display plate or the like using the built-in camera. The user terminal 1 extracts activation information included in the information code by analyzing the captured information code. The user terminal 1 activates an authentication assistance function using the extracted activation information. When activated, the authentication assistance function controls the built-in camera to capture an image of a face of a user who is a possessor of the user terminal 1. Alternatively, the authentication assistance function may prompt the user to press an imaging button. Accordingly, the user terminal 1 acquires a face image of the user, and outputs biometric information based on the face image so that a biometric authentication is performed by an external authentication control apparatus.

In recent years, a built-in camera is generally mounted on a user terminal (mobile terminal). Therefore, in the first example embodiment, a biometric authentication performed by the authentication control apparatus is assisted by causing the user terminal to read an information code including activation information as a trigger. Therefore, it is unnecessary to install a camera for acquiring biometric information on the authentication control apparatus side. Based on the above, it is possible to suppress biometric authentication introduction costs while securing reliability of identity authentication.

Note that the biometric authentication is performed in such a manner that biometric information of a person is extracted from a captured image, the extracted biometric information is collated with biometric information registered in advance, and it is considered that the authentication has succeeded when the matching degree is greater than or equal to a threshold value. Here, as the biometric information, data (feature amount) calculated from a physical feature unique to an individual, such as facial feature information, a fingerprint, a voiceprint, a vein, a retina, an iris of a pupil, or a pattern (pattern) of a palm, may be used.

Note that the user terminal 1 includes a processor, a memory, and a storage device as components that are not illustrated. In addition, the storage device stores a computer program (or an authentication assistance program) by which the processing of the authentication assistance method according to the present example embodiment is implemented. Then, the processor reads the computer program or the like from the storage device into the memory and executes the computer program. As a result, the processor implements the functions of the imaging unit 11, the activation unit 12, the acquisition unit 13, and the output unit 14.

Alternatively, each component of the user terminal 1 may be implemented by dedicated hardware. In addition, some or all of the components of each apparatus may be implemented by general-purpose or dedicated circuitry, a processor, or a combination thereof. These may be configured by a single chip or may be configured by a plurality of chips connected to each other via a bus. Some or all of the components of each apparatus may be implemented by, for example, a combination of the above-described circuitry and a program. Furthermore, a central processing unit (CPU), a graphics processing unit (GPU), a field-programmable gate array (FPGA), or a quantum processor (quantum computer control chip) can be used as the processor.

### Second Example Embodiment

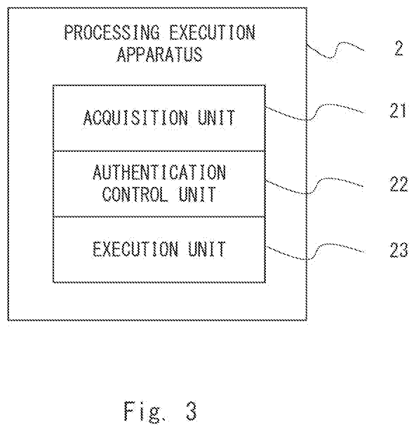

FIG. 3 is a block diagram illustrating a configuration of a processing execution apparatus 2 according to the second example embodiment. The processing execution apparatus 2 is the above-described authentication control apparatus, or an information processing apparatus that controls a biometric authentication using the authentication control apparatus and executes predetermined processing according to success of the biometric authentication. The processing execution apparatus 2 includes an acquisition unit 21, an authentication control unit 22, and an execution unit 23.

The acquisition unit 21 acquires, from a user terminal, biometric information based on a face image of a user who is a possessor of the user terminal. Here, the user terminal corresponds to the user terminal 1 according to the first example embodiment described above. Therefore, it can be said that the acquisition unit 21 acquires the biometric information based on the image including the face of the user captured by the user terminal according to the authentication assistance function of the user terminal activated based on the predetermined activation information included in the information code captured by the user terminal.

When the biometric information is acquired, the authentication control unit 22 controls a biometric authentication for the user. For example, in a case where biometric information for registration of the user is registered in advance, the authentication control unit 22 performs a biometric authentication by collating the acquired biometric information with the biometric information for registration. Alternatively, in a case where biometric information for registration of the user is registered in advance in an external authentication control apparatus, the authentication control unit 22 may transmit the acquired biometric information to the authentication control apparatus so that the authentication control apparatus performs biometric authentication processing, and receive a biometric authentication result.

When the biometric authentication has succeeded, the execution unit 23 executes predetermined processing. Here, the predetermined processing is, for example, payment processing or the like, but is not limited thereto.

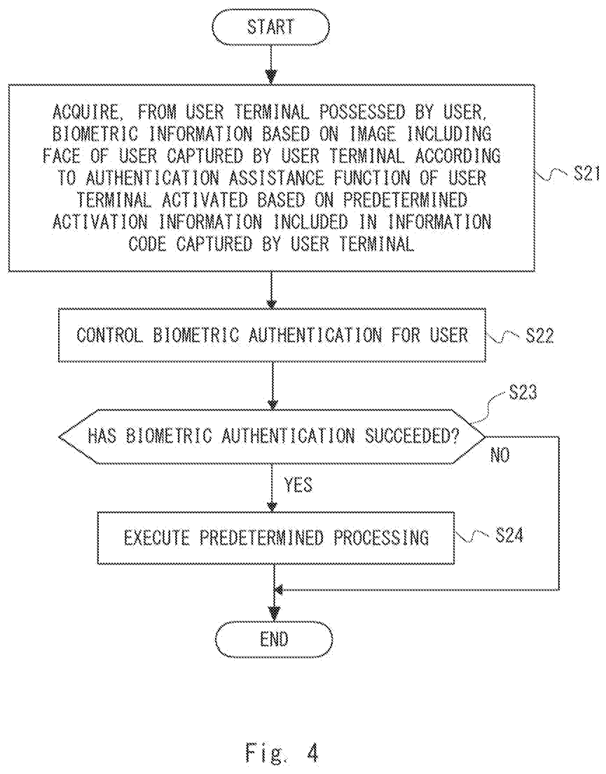

FIG. 4 is a flowchart illustrating a flow of a processing execution method according to the second example embodiment. First, the acquisition unit 21 acquires biometric information based on an image including a face of a user from the user terminal (S21). Here, the image including the face of the user is captured by the user terminal according to an authentication assistance function of the user terminal activated based on predetermined activation information included in the information code captured by the user terminal possessed by the user.

Next, when the biometric information is acquired, the authentication control unit 22 controls a biometric authentication for the user (S22). Then, the authentication control unit 22 determines whether the biometric authentication has succeeded (S23). When the biometric authentication has succeeded, the execution unit 23 executes predetermined processing (S24). On the other hand, when the biometric authentication has failed, the processing ends.

As described above, in the second example embodiment, for example, it is assumed that a user terminal possessed by a user captures an information code displayed on the display plate installed near the processing execution apparatus 2 using its built-in camera. Then, it is assumed that the authentication assistance function of the user terminal is activated accordingly, a face image of the user is captured in advance by the camera built in the user terminal, and biometric information based on the face image is output for biometric authentication. Therefore, the processing execution apparatus 2 can control a biometric authentication using the acquired biometric information, and perform predetermined processing according to the success of the biometric authentication. As a result, it is unnecessary to install a camera for acquiring biometric information near the processing execution apparatus 2. Based on the above, in the second example embodiment as well, it is possible to suppress biometric authentication introduction costs while securing reliability of identity authentication.

Note that the processing execution apparatus 2 includes a processor, a memory, and a storage device as components that are not illustrated. In addition, the storage device stores a computer program by which the processing of the processing execution method according to the present example embodiment is implemented. Then, the processor reads the computer program from the storage device into the memory and executes the computer program. As a result, the processor implements the functions of the acquisition unit 21, the authentication control unit 22, and the execution unit 23.

Alternatively, each component of the processing execution apparatus 2 may be implemented by dedicated hardware. In addition, some or all of the components of each apparatus may be implemented by general-purpose or dedicated circuitry, a processor, or a combination thereof. These may be configured by a single chip or may be configured by a plurality of chips connected to each other via a bus. Some or all of the components of each apparatus may be implemented by, for example, a combination of the above-described circuitry and a program. Furthermore, a central processing unit (CPU), a graphics processing unit (GPU), a field-programmable gate array (FPGA), or a quantum processor (quantum computer control chip) can be used as the processor.

Furthermore, in a case where some or all of the components of the processing execution apparatus 2 are implemented by a plurality of information processing apparatuses, circuits, and the like, the plurality of information processing apparatuses, circuits, and the like may be arranged in a centralized manner or in a distributed manner. For example, the information processing apparatuses, the circuits, and the like may be implemented in the form of a client server system, a cloud computing system, or the like in which they are connected to each other via a communication network. In addition, the function of the processing execution apparatus 2 may be provided in a software as a service (SaaS) format.

### Third Example Embodiment

The third example embodiment is a specific example of the first and second example embodiments described above. In the third example embodiment, an example in which the predetermined processing according to the biometric authentication performed by the processing execution apparatus is payment processing according to a face authentication in a store will be described. Note that the predetermined processing according to the biometric authentication is not limited thereto.

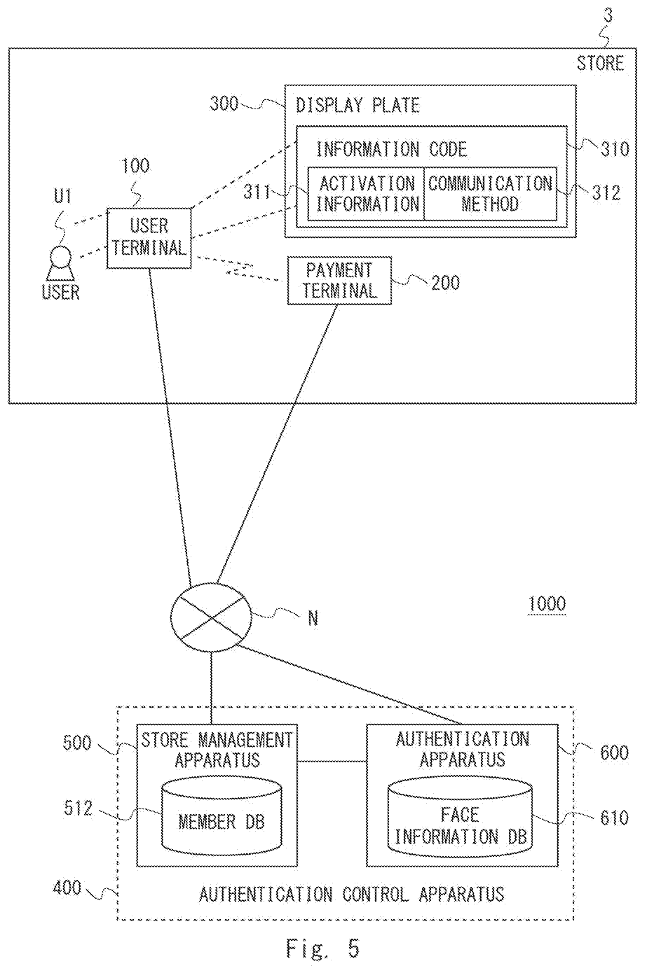

FIG. 5 is a block diagram illustrating an overall configuration of an authentication system 1000 according to the third example embodiment. The authentication system 1000 is an information system for a store visitor (user U1) of the store 3 to perform payment processing based on face authentication using his/her user terminal 100 in cooperation with a payment terminal 200. For example, the user U1 captures an information code 310 of a display plate 300 installed near the payment terminal 200 at the time of payment with a camera of the user terminal 100. Here, the information code 310 includes activation information 311 and a communication method 312. The activation information 311 includes information for activating an authentication assistance program installed in the user terminal 100. The communication method 312 includes designation of a method of communication between the user terminal 100 and the payment terminal 200. Accordingly, the user terminal 100 activates the authentication assistance program and images a face of the user U1. Then, the user terminal 100 transmits facial feature information based on the captured face image to the payment terminal 200 by short-range wireless communication. The payment terminal 200 transmits the facial feature information received by the short-range wireless communication to the authentication control apparatus 400, and receives a face authentication result. When the face authentication has succeeded, the payment terminal 200 performs payment processing for the user U1 in conjunction with the store management apparatus 500.

The authentication system 1000 includes a user terminal 100, a payment terminal 200, a store management apparatus 500, and an authentication apparatus 600. The store management apparatus 500 and the authentication apparatus 600 may be collectively referred to as an authentication control apparatus 400. The user terminal 100, the payment terminal 200, the store management apparatus 500, and the authentication apparatus 600 are communicably connected to each other via a network N. Here, the network N is a wired or wireless communication line or communication network, and is, for example, an in-store local area network (LAN), the Internet, a wireless communication line network, a mobile phone line network, or the like. The network N may be of any type of communication protocol.

It is assumed that the user U1 has registered his/her face image or facial feature information in advance in a face information database (DB) 610 of the authentication apparatus 600. In addition, it is assumed that the user U1 has registered his/her payment information (credit card information, withdrawal bank account information, or the like) in a member DB 512 in advance.

The store management apparatus 500 is an information processing apparatus for performing various kinds of management for the store 3. The store management apparatus 500 may be redundant in a plurality of servers, and each functional block of the store management apparatus 500 may be implemented by a plurality of computers.

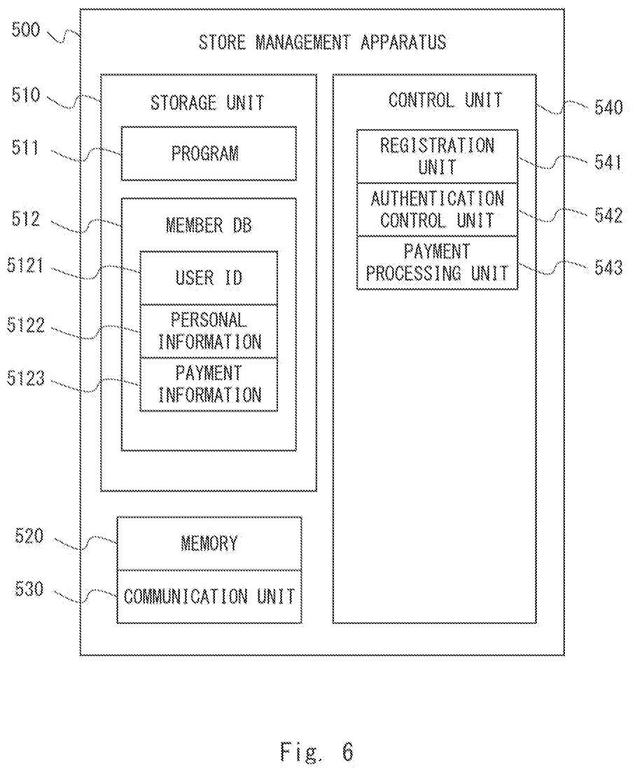

FIG. 6 is a block diagram illustrating a configuration of the store management apparatus 500 according to the third example embodiment. The store management apparatus 500 includes a storage unit 510, a memory 520, a communication unit 530, and a control unit 540. The storage unit 510 is an example of a storage device such as a hard disk or a flash memory. The storage unit 510 stores a program 511 and a member DB 512. The program 511 is a computer program by which some of processing of registration of face information and member information, face authentication processing, payment processing, and the like according to the third example embodiment are implemented.

The member DB 512 is a database for managing information about persons registered as members among people who have visited the store 3. In the member DB 512, a user ID 5121, personal information 5122, and payment information 5123 are managed in association with each other. The user ID 5121 is identification information of a user who is a member of the store 3. The user ID 5121 is information corresponding to a user ID 611 of face information DB 610 to be described below. The personal information 5122 is information including the user's name, address, telephone number, notification destination, and the like. The notification destination is identification information (terminal ID) of a user terminal possessed by the user, a login ID of the user, an e-mail address of the user, an account of a social networking service (SNS) of the user, or the like. The payment information 5123 is credit card information, withdrawal bank account information, or the like used when the payment terminal 200 performs payment processing according to the success of the biometric authentication.

The memory 520 is a volatile storage device such as a random access memory (RAM), and is a storage area for temporarily holding information during the operation of the control unit 540. The communication unit 530 is a communication interface with the network N.

The control unit 540 is a processor that controls each component of the store management apparatus 500, that is, a control apparatus. The control unit 540 reads the program 511 from the storage unit 510 into the memory 520 and executes the program 511. As a result, the control unit 540 implements the functions of the registration unit 541, the authentication control unit 542, and the payment processing unit 543.

The registration unit 541 receives a member registration request including a face image, personal information, and payment information from a certain user terminal 100, and performs processing of registration of face information and member information. Specifically, the registration unit 541 acquires a face image from the member registration request, and transmits a face information registration request including the acquired face image to the authentication apparatus 600. Then, the registration unit 541 receives a user ID issued by the authentication apparatus 600 at the time of registering the face information from the authentication apparatus 600. In addition, the registration unit 541 acquires personal information and payment information from the member registration request, and registers the received user ID 5121, the acquired personal information 5122, and the acquired payment information 5123 in association with each other in the member DB 512.

When receiving a pre-authentication request including a face image of a user from a user terminal 100, the authentication control unit 542 transmits a face authentication request (request for first biometric authentication) including the face image to the authentication apparatus 600. Then, the authentication control unit 542 receives a face authentication result from the authentication apparatus 600.

When receiving a payment request from the payment terminal 200, the payment processing unit 543 performs payment processing. Specifically, the payment processing unit 543 acquires a user ID and a payment amount from the payment request, and reads payment information 5123 associated with the user ID 5121 acquired from the member DB 512. Then, the payment processing unit 543 performs payment processing for the payment amount using the payment information 5123. Then, the payment processing unit 543 transmits a payment result to the payment terminal 200.

Returning to FIG. 5, the description will be continued.

The authentication apparatus 600 is an information processing apparatus that manages facial feature information of the user and performs a face authentication. In response to a face authentication request received from the outside, the authentication apparatus 600 collates a face image or facial feature information included in the request with the facial feature information of each user, and transmits a collation result (authentication result) as a response to the request source.

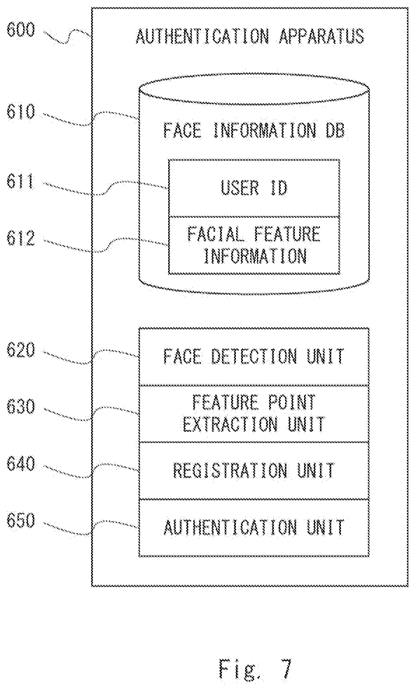

FIG. 7 is a block diagram illustrating a configuration of the authentication apparatus 600 according to the third example embodiment. The authentication apparatus 600 includes a face information DB 610, a face detection unit 620, a feature point extraction unit 630, a registration unit 640, and an authentication unit 650. The face information DB 610 stores a user ID 611 and facial feature information 612 of the user ID in association with each other. The facial feature information 612 is a set of feature points extracted from a face image. Note that the authentication apparatus 600 may delete facial feature information 612 in the face feature DB 610 in response to a request from a user or the like corresponding to the facial feature information 612. Alternatively, the authentication apparatus 600 may delete facial feature information 612 after a lapse of a certain period from the registration of the facial feature information 612.

The face detection unit 620 detects a face area included in the image registered for registering face information, and outputs the face area to the feature point extraction unit 630. The feature point extraction unit 630 extracts feature points from the face area detected by the face detection unit 620, and outputs facial feature information to the registration unit 640. In addition, the feature point extraction unit 630 extracts feature points included in a face image received from the store management apparatus 500 or the like, and outputs facial feature information to the authentication unit 650.

The registration unit 640 newly issues a user ID 611 when registering the facial feature information. The registration unit 640 registers the issued user ID 611 and the facial feature information 612 extracted from the registered image in association with each other in the face information DB 610. The authentication unit 650 performs a face authentication using the facial feature information 612. Specifically, the authentication unit 650 collates the facial feature information extracted from the face image with the facial feature information 612 in the face information DB 610. When the collation has succeeded, the authentication unit 650 specifies a user ID 611 associated with the collated facial feature information 612. The authentication unit 650 transmits as a response whether the pieces of facial feature information match each other as a face authentication result to the request source. Whether the pieces of facial feature information match each other corresponds to whether the authentication has succeeded or failed. The match between the pieces of facial feature information means that the matching degree is greater than or equal to a threshold value. In addition, it is assumed that the face authentication result includes the specified user ID when the face authentication has succeeded.

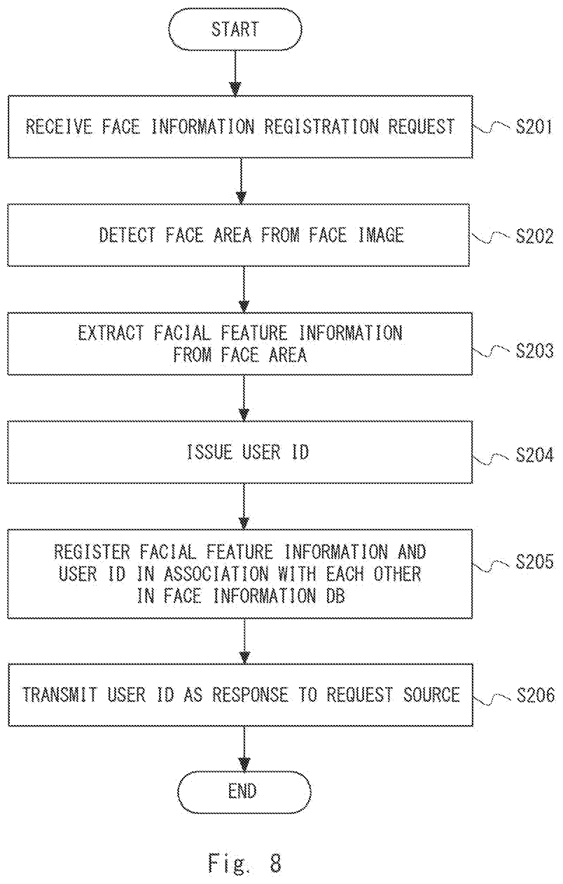

FIG. 8 is a flowchart illustrating a flow of face information registration processing performed by the authentication apparatus 600 according to the third example embodiment. First, the authentication apparatus 600 receives a face information registration request (S201). For example, the authentication apparatus 600 receives the face information registration request from the store management apparatus 500 via the network N. Next, the face detection unit 620 detects a face area from a face image included in the face information registration request (S202). Then, the feature point extraction unit 630 extracts feature points (facial feature information) from the face area detected in step S202 (S203). Then, the registration unit 640 issues a user ID 611 (S204). Then, the registration unit 640 registers the extracted facial feature information 612 and the issued user ID 611 in association with each other in the face information DB 610 (S205). Thereafter, the registration unit 640 transmits, as a response, the issued user ID 611 to a request source (e.g., the store management apparatus 500) (S206). Note that the authentication apparatus 600 may perform face information registration processing in response to a face information registration request received from any information registration terminal. For example, the information registration terminal is an information processing apparatus such as a personal computer, a smartphone, or a tablet terminal. In addition, the information registration terminal may be the user terminal 100.

Returning to FIG. 5, the description will be continued.

The user terminal 100 is an example of the user terminal 1 described above. The user terminal 100 is an information terminal that can be carried by the user U1 and is capable of wireless communication. Here, it is assumed that the user U1 and the user terminal 100 exist near the payment terminal 200 in the store 3. That is, it is assumed that the user terminal 100 exists at a position where the information code 310 displayed on the display plate 300 can be captured and at a distance where short-range wireless communication with the payment terminal 200 can be performed.

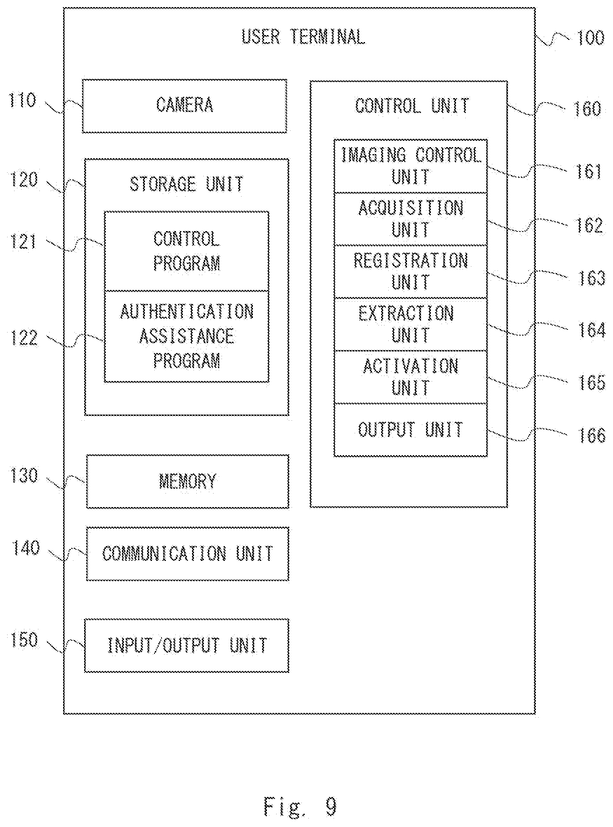

FIG. 9 is a block diagram illustrating a configuration of the user terminal 100 according to the third example embodiment. The user terminal 100 includes a camera 110, a storage unit 120, a memory 130, a communication unit 140, an input/output unit 150, and a control unit 160. The camera 110 is an imaging device that performs imaging under the control of the control unit 160. The storage unit 120 is a storage device such as a flash memory. The storage unit 120 stores a control program 121 and an authentication assistance program 122. The control program 121 is a computer program by which processing of registering face information and member information, processing of analyzing an information code, processing of activating the authentication assistance program 122, and the like are implemented. In addition, by the control program 121, processing of imaging a face, processing of extracting facial feature information, processing of outputting a face image or facial feature information may be implemented according to the activation of the authentication assistance program 122. The authentication assistance program 122 is a computer program by which the processing of the authentication assistance function described above is implemented. The authentication assistance program 122 controls the camera 110 according to activation. In addition, by the authentication assistance program 122, processing of imaging a face, processing of extracting facial feature information, processing of outputting a face image or facial feature information may be implemented.

The memory 130 is a volatile storage device such as a RAM, and is a storage area for temporarily holding information during the operation of the control unit 160. The communication unit 140 is a communication interface with the network N. In particular, the communication unit 140 performs wireless communication. For example, the communication unit 140 establishes connection with radio base stations inside and outside the store 3 to perform communication. Furthermore, the communication unit 140 may establish connection for short-range wireless communication with the payment terminal 200 to perform communication. Here, various standards such as Bluetooth (registered trademark), Bluetooth Low Energy (BLE), and Ultra Wide Band (UWB) can be applied to the short-range wireless communication. Furthermore, the communication unit 140 may communicate with a global positioning system

(GPS) satellite to acquire position information. The input/output unit 150 includes a display apparatus (display unit) such as a screen and an input apparatus. The input/output unit 150 is, for example, a touch panel. The control unit 160 is a processor that controls hardware included in the user terminal 100. The control unit 160 reads the control program 121 and the authentication assistance program 122 from the storage unit 120 into the memory 130, and executes the control program 121 and the authentication assistance program 122. As a result, the control unit 160 implements the functions of an imaging control unit 161, an acquisition unit 162, a registration unit 163, an extraction unit 164, an activation unit 165, and an output unit 166.

The imaging control unit 161 is an example of the imaging unit 11 described above. Alternatively, the imaging control unit 161 may be combined with the camera 110 to realize the imaging unit 11. The imaging control unit 161 controls the camera 110 to capture an image according to an operation of the user U1 or an instruction from the authentication assistance program 122. For example, the imaging control unit 161 causes the camera 110 to capture the information code 310 displayed on the information code 310. Furthermore, the imaging control unit 161 causes the camera 110 to image the face of the user U1.

The acquisition unit 162 is an example of the acquisition unit 13 described above. The acquisition unit 162 acquires an image captured by the camera 110. Specifically, the acquisition unit 162 acquires an image of the information code 310 and a face image of the user U1. For example, the acquisition unit 162 acquires an image including the face of the user U1 captured by the imaging control unit 161 according to the activation of the authentication assistance program 122.

The registration unit 163 performs processing of registration of user's face information and member information. Specifically, the registration unit 163 transmits a member registration request including a face image, personal information, and payment information of the user to the store management apparatus 500. As a result, as described above, the facial feature information of the user is registered in the face information DB 610 of the authentication apparatus 600, and the member information is registered in the member DB 512 of the store management apparatus 500.

The extraction unit 164 extracts activation information 311 and a communication method 312 by analyzing the image of the information code 310 acquired by the acquisition unit 162. The activation information 311 includes a character string of commands for activating the authentication assistance program 122. Alternatively, the activation information 311 may include a program file name of the authentication assistance program 122. Furthermore, the communication method 312 includes designation of a method for communicating a face image or facial feature information. It is assumed that, as the communication method 312 according to the third example embodiment, any of the above-described short-range wireless communication methods, for example, BLE is designated. Furthermore, the extraction unit 164 may extract facial feature information from the face image acquired by the acquisition unit 162.

The activation unit 165 is an example of the activation unit 12 described above. The activation unit 165 activates the authentication assistance program 122 using the activation information 311.

The output unit 166 is an example of the output unit 14 described above. The output unit 166 outputs the face image or the facial feature information for face authentication via the payment terminal 200 according to the communication method 312 designated by the information code 310. Specifically, the output unit 166 outputs the face image or the facial feature information by short-range wireless communication. For example, the output unit 166 may output the face image or the like by BLE broadcast communication. Alternatively, the output unit 166 may establish wireless communication with the payment terminal 200 by BLE, and output the face image or the like to the payment terminal 200.

Returning to FIG. 5, the description will be continued.

The payment terminal 200 is an example of the processing execution apparatus 2 described above. The payment terminal 200 is an information processing apparatus installed at a payment place in the store 3 to perform payment processing according to the success of the face authentication. The payment terminal 200 may be either a manned cash register terminal or an unmanned cash register terminal. In addition, the payment terminal 200 controls a face authentication using the authentication control apparatus 400. In addition, the display plate 300 is posted near the payment terminal 200. In particular, the payment terminal 200 performs a face authentication when acquiring the face image or the like from the user terminal 100 that has read the information code 310 on the display plate 300 and captured the face image, and performs payment processing when the face authentication has succeeded.

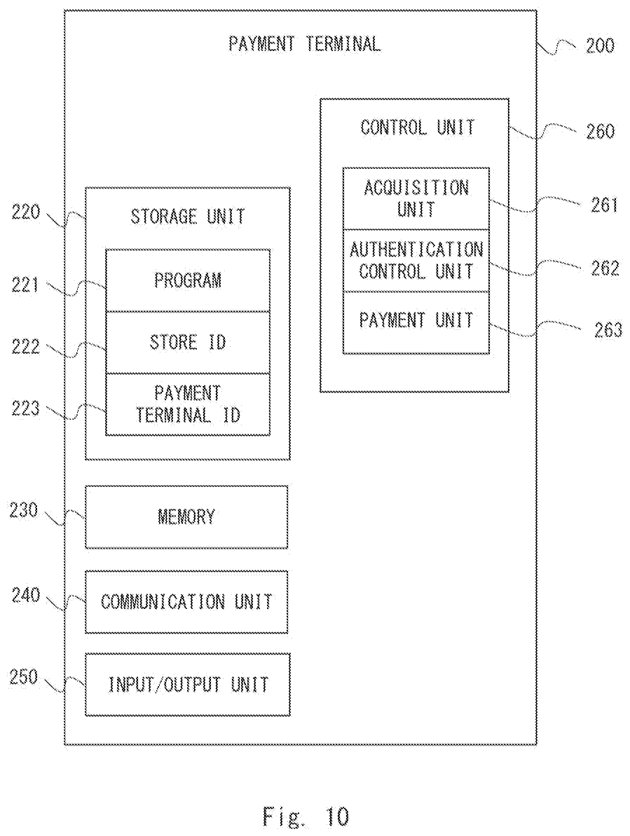

FIG. 10 is a block diagram illustrating a configuration of the payment terminal 200 according to the third example embodiment. The payment terminal 200 includes a storage unit 220, a memory 230, a communication unit 240, an input/output unit 250, and a control unit 260. The storage unit 220 is an example of a storage device such as a hard disk or a flash memory. The storage unit 220 stores a program 221, a store ID 222, and a payment terminal ID 223. The program 221 is a computer program by which processing including payment processing according to the third example embodiment is implemented. The store ID 222 is identification information of the store 3. The payment terminal ID 223 is identification information of the payment terminal 200 in the store 3. Note that identification information for uniquely identifying the store 3 and the payment terminal 200 may be used instead of the store ID 222 and the payment terminal ID 223.

The memory 230 is a volatile storage device such as a RAM, and is a storage area for temporarily holding information during the operation of the control unit 260. The communication unit 240 is a communication interface with the network N. The communication unit 240 may establish connection for short-range wireless communication with the user terminal 100 to perform communication. The input/output unit 250 includes a display apparatus (display unit) such as a screen and an input apparatus. The input/output unit 250 is, for example, a touch panel. The control unit 260 is a processor that controls hardware included in the payment terminal 200. The control unit 260 reads the program 221 from the storage unit 220 into the memory 230, and executes the program. As a result, the control unit 260 implements the functions of the acquisition unit 261, the authentication control unit 262, and the payment unit 263.

The acquisition unit 261 is an example of the acquisition unit 21 described above. The acquisition unit 261 acquires a face image or facial feature information from the user terminal 100 by short-range wireless communication.

The authentication control unit 262 is an example of the authentication control unit 22 described above. When the face image or the like is acquired by the acquisition unit 261, the authentication control unit 262 controls a face authentication. Specifically, the authentication control unit 262 transmits a face authentication request including the face image or the like to the authentication control apparatus 400 (the store management apparatus 500 or the authentication apparatus 600). The authentication control unit 262 may include the face image itself or a face feature amount extracted from the face image, as biometric information, in the face authentication request. Then, the authentication control unit 262 receives a face authentication result from the authentication control apparatus 400.

The payment unit 263 is an example of the execution unit 23 described above. The payment unit 263 executes payment processing when the face authentication result indicates success. Specifically, as will be described below, the payment unit 263 performs payment processing for the user who has succeeded in the face authentication, using the store management apparatus 500.

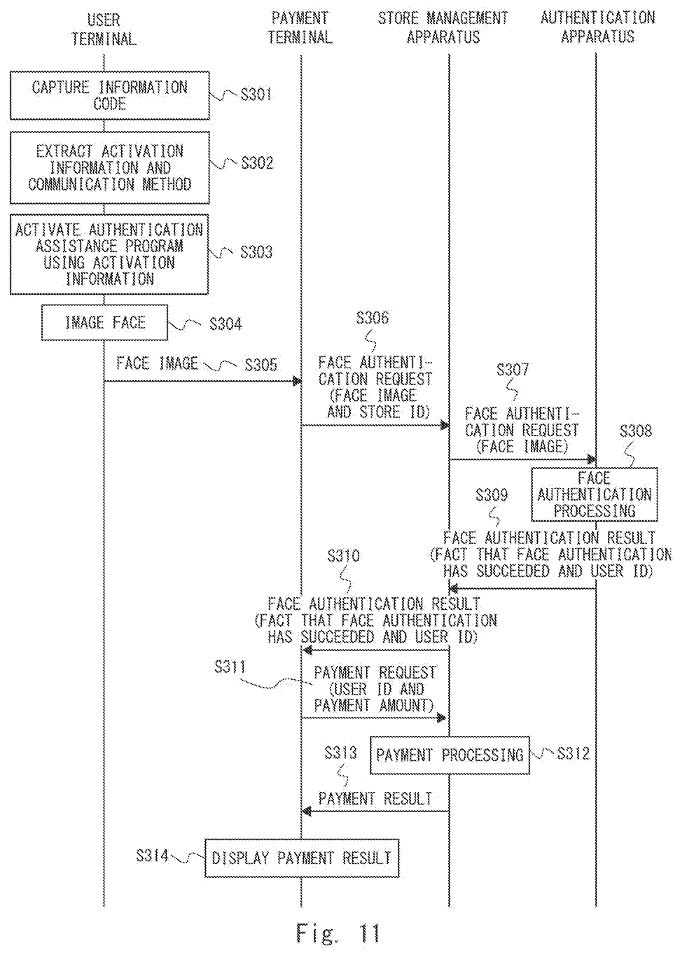

FIG. 11 is a sequence diagram illustrating a flow of payment processing according to the third example embodiment. First, the user terminal 100 captures an information code 310 displayed on the display plate 300 by the camera 110 (S301). Next, the user terminal 100 extracts activation information 311 and a communication method 312 by analyzing the captured information code 310 (S302). Then, the user terminal 100 activates the authentication assistance program 122 using the activation information 311 (S303). For example, the activation unit 165 executes a command for activating the authentication assistance program 122. Accordingly, the user terminal 100 may activate an application for the authentication assistance function. The imaging control unit 161 of the user terminal 100 controls the camera 110 to image the face of the user U1 according to an instruction from the authentication assistance program 122 (S304). At this time, the imaging control unit 161 may receive an imaging instruction from the user U1. Then, the user terminal 100 outputs a face image according to the communication method 312 (S305). Here, it is assumed that the user terminal 100 and the payment terminal 200 exist at a distance within a range in which short-range wireless communication can be performed therebetween. The user terminal 100 may output the face image according to an instruction from the authentication assistance program 122.

Subsequently, the payment terminal 200 acquires the face image output from the user terminal 100 by short-range wireless communication. Then, the payment terminal 200 transmits a face authentication request including the acquired face image and a store ID 222 to the store management apparatus 500 via the network N (S306). Note that the face authentication request does not necessarily include the store ID 222.

The store management apparatus 500 receives the face authentication request from the payment terminal 200 via the network N, and transmits the face authentication request including the face image to the authentication apparatus 600 via the network N (S307). Accordingly, the authentication apparatus 600 receives the face authentication request from the store management apparatus 500 via the network N, and performs face authentication processing (S308).

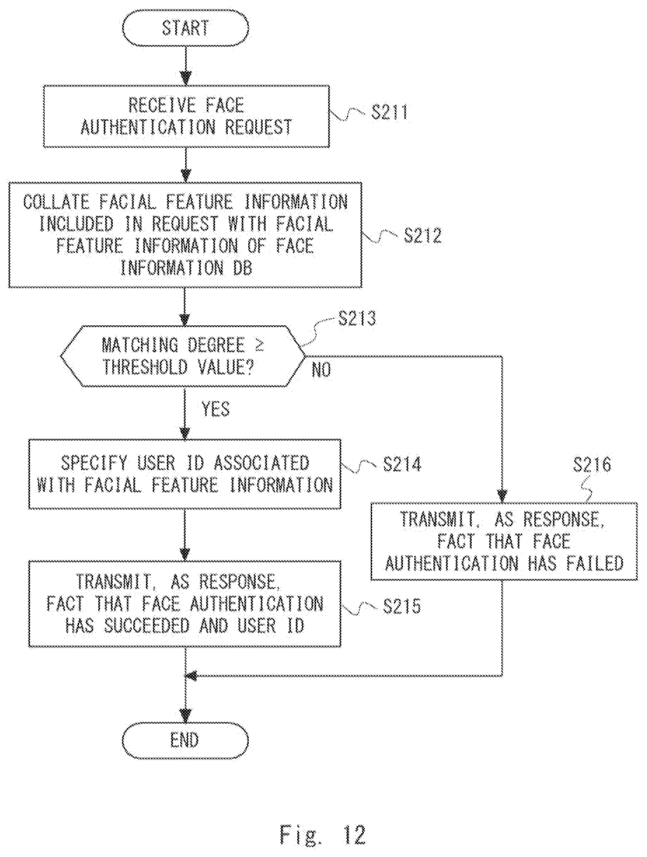

FIG. 12 is a flowchart illustrating a flow of face authentication processing performed by the authentication apparatus 600 according to the third example embodiment. First, the authentication apparatus 600 receives a face authentication request from the store management apparatus 500 via the network N (S211). Note that the authentication apparatus 600 may receive a face authentication request from the user terminal 100, the payment terminal 200, or the like. Next, the authentication apparatus 600 extracts facial feature information from the face image included in the face authentication request, similarly to steps S202 and S203 described above. Then, the authentication unit 650 of the authentication apparatus 600 collates the facial feature information extracted from the face image included in the face authentication request with the facial feature information 612 of the face information DB 610 (S212), and calculates a matching degree. Then, the authentication unit 650 determines whether the matching degree is greater than or equal to a threshold value (S213). When the pieces of facial feature information match, that is, when the matching degree between the pieces of facial feature information is greater than or equal to the threshold value, the authentication unit 650 specifies a user ID 611 associated with the facial feature information 612 (S214). Then, the authentication unit 650 transmits, as a response, a face authentication result including the fact that the face authentication has succeeded and the specified user ID 611 to the store management apparatus 500 via the network N (S215). When the matching degree is smaller than the threshold value in step S213, the authentication unit 650 transmits, as a response, a face authentication result including the fact that the face authentication has failed to the store management apparatus 500 via the network N (S216).

Returning to FIG. 11, the description will be continued.

Thereafter, the store management apparatus 500 receives a face authentication result from the authentication apparatus 600 via the network N (S309). Then, the store management apparatus 500 transmits the received face authentication result to the payment terminal 200 via the network N (S310). Accordingly, the payment terminal 200 receives the face authentication result from the store management apparatus 500 via the network N.

Note that the payment terminal 200 may directly transmit a face authentication request to the authentication apparatus 600 without passing through the store management apparatus 500, and may directly receive a face authentication result from the authentication apparatus 600.

Then, the payment terminal 200 determines whether the face authentication has succeeded based on the face authentication result. When the face authentication result indicates that the face authentication has failed, the payment terminal 200 displays, on a screen, the fact that the authentication has failed, that is, the fact that it is not allowed to make a payment based on face authentication. Furthermore, the payment terminal 200 may notify the user terminal 100, by short-range wireless communication, that it is not allowed to make a payment based on face authentication.

Here, it is assumed that the face authentication result includes the fact that the face authentication has succeeded and the user ID of the user U1. Therefore, the payment terminal 200 determines that the user U1 has succeeded in the face authentication. The payment terminal 200 transmits a payment request including the user ID and a payment amount for a product or the like to be purchased by the user U1 to the store management apparatus 500 via the network N (S311). Accordingly, the store management apparatus 500 receives the payment request from the payment terminal 200 via the network N, and performs payment processing (S312). Specifically, the payment processing unit 543 of the store management apparatus 500 acquires the user ID and the payment amount from the received payment request, and reads payment information 5123 associated with the user ID 5121 acquired from the member DB 512. Then, the payment processing unit 543 performs payment processing for the payment amount using the payment information 5123. Then, the payment processing unit 543 transmits a payment result to the payment terminal 200 via the network N (S313). Accordingly, the payment terminal 200 receives the payment result from the store management apparatus 500 via the network N, and displays the payment result on the screen (S314). Furthermore, the payment terminal 200 may notify the user terminal 100 of the payment result by short-range wireless communication.

As described above, in the present example embodiment, the store side can introduce payment processing based on face authentication without having to installing a camera for face authentication, thereby suppressing costs. In addition, the user side takes a photograph of his/her face as a “selfie”, rather than having the photograph of the face taken by the store side. Therefore, the psychological hurdle to face authentication can be lowered, and the use of the payment processing based on face authentication can be promoted.

The information code 310 according to the present example embodiment does not necessarily include the communication method 312. In that case, for example, a method of short-range wireless communication between the user terminal 100 and the payment terminal 200 may be determined in advance.

### Fourth Example Embodiment

The fourth example embodiment is a modified example of the third example embodiment described above. The information code according to the fourth example embodiment includes a payment terminal ID. The user terminal designates a payment terminal ID included in an information code among a plurality of payment terminals in the store as a payment terminal to be used by the user for payment, and outputs a face image or the like.

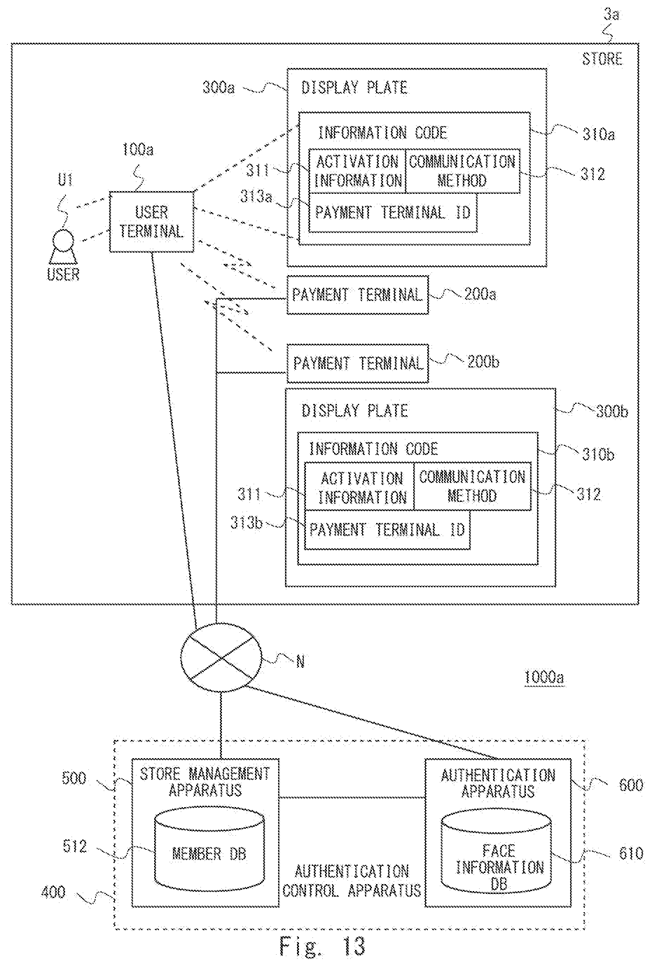

FIG. 13 is a block diagram illustrating an overall configuration of an authentication system 1000a according to the fourth example embodiment. As compared with the authentication system 1000 described above, the authentication system 1000a includes a plurality of sets of payment terminals and display plates in a store 3a. Note that, hereinafter, differences from the above-described third example embodiment will be mainly described, and redundant description and illustration will be appropriately omitted.

Specifically, a display plate 300a is installed near a payment terminal 200a. An information code 310a is displayed on the display plate 300a, and the information code 310a includes a payment terminal ID 313a in addition to the activation information 311 and the communication method 312. The payment terminal ID 313a is identification information of the payment terminal 200a. In addition, a display plate 300b is installed near a payment terminal 200b. An information code 310b is displayed on the display plate 300b, and the information code 310b includes a payment terminal ID 313b in addition to the activation information 311 and the communication method 312. The payment terminal ID 313b is identification information of the payment terminal 200b. Therefore, it can be said that each of the information codes 310a and 310b includes terminal information that is a destination to which biometric information is output. Note that each of the information codes 310a and 310b does not necessarily include the communication method 312. In that case, for example, a method of short-range wireless communication between the user terminal 100 and each of the payment terminals 200a and 200b may be determined in advance.

In addition, it is assumed that each of the payment terminals 200a and 200b and the user terminal 100a exist at a communicable distance by predetermined short-range wireless communication. That is, when a face image or the like is output from the user terminal 100a by short-range wireless communication, the face image or the like may be receivable by both of the payment terminals 200a and 200b.

The functions of the user terminal 100a are different from the functions of the user terminal 100 described above in information code extraction processing and face image output processing. Specifically, the user terminal 100a extracts a payment terminal ID, in addition to the activation information and the communication method, by analyzing the acquired image of the information code. Furthermore, the user terminal 100a outputs the face image or the like by short-range wireless communication using the extracted payment terminal ID as an output destination.

When receiving the face image or the like by short-range wireless communication, each of the payment terminals 200a and 200b determines whether the payment terminal ID designated as the output destination matches the payment terminal ID 223 of itself. When the payment terminal IDs do not match, the payment terminal 200a or the like does not perform subsequent face authentication processing or the like.

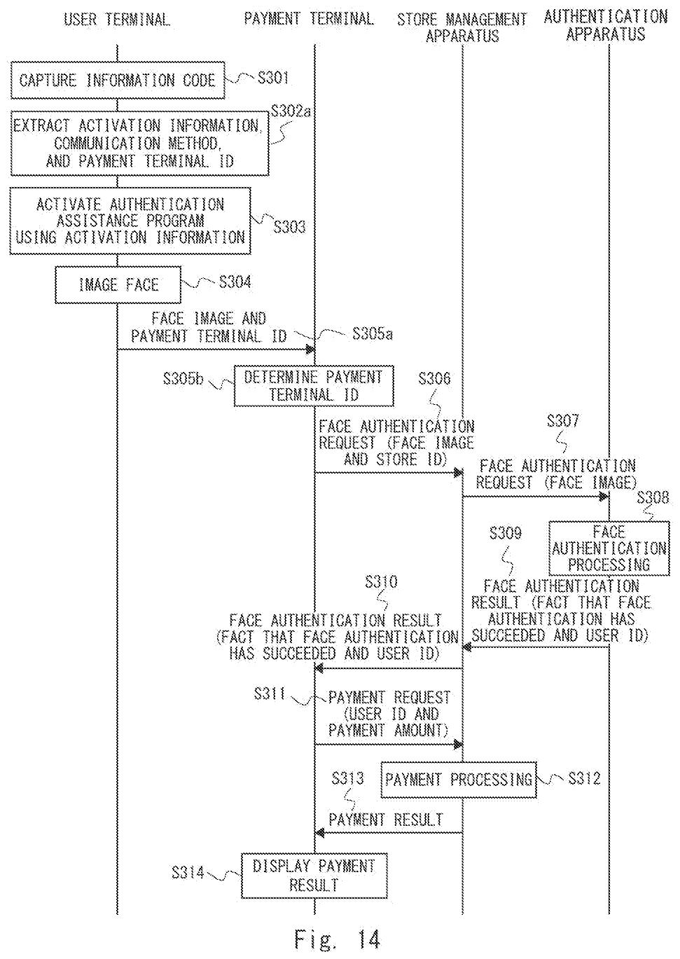

FIG. 14 is a sequence diagram illustrating a flow of payment processing according to the fourth example embodiment. Here, differences from FIG. 11 described above will be mainly described. As a premise, it is assumed that the user terminal 100a exists in front of the display plate 300a and the payment terminal 200a. Furthermore, it is assumed that the user terminal 100a exists at a distance capable of short-range wireless communication with both of the payment terminals 200a and 200b.

First, the user terminal 100a captures an information code 310a displayed on the display plate 300a by the camera 110 (S301). Next, the user terminal 100a extracts activation information 311, a communication method 312, and a payment terminal ID 313a by analyzing the captured information code 310a (S302a). Then, after steps S303 and S304, the user terminal 100a outputs a face image or the like by short-range wireless communication with the payment terminal ID 313a as an output destination (S305a). For example, the user terminal 100a may designate the payment terminal ID 313a as a destination of short-range wireless communication to perform broadcast communication.

Subsequently, the payment terminal 200a acquires the face image output from the user terminal 100 by short-range wireless communication. Then, the payment terminal 200a determines whether the payment terminal ID designated as a destination of the acquired signal matches the payment terminal ID 223 of itself (S305b). Here, it is assumed that they match, and thereafter, the payment terminal 200a performs step S306 and the subsequent steps similarly to FIG. 11 described above.

On the other hand, the payment terminal 200b acquires a face image output from the user terminal 100 by short-range wireless communication, and determines whether the payment terminal ID designated as a destination of the acquired signal matches the payment terminal ID 223 of itself. Here, since they do not match, the payment terminal 200b does not perform the subsequent processing.

Note that the user terminal 100a may output a signal requesting establishment of connection for short-range wireless communication with the payment terminal ID 313a designated therein. In this case, the payment terminal 200a receives the signal requesting establishment of connection. Then, since the payment terminal ID 313a is designated in the connection establishment request, the payment terminal 200a responds to the user terminal 100a according to the connection establishment request. That is, the payment terminal 200a establishes connection for short-range wireless communication with the user terminal 100a.

After establishing the connection for short-range wireless communication with the payment terminal 200a, the user terminal 100a transmits a face image or the like by the short-range wireless communication with the payment terminal ID 313a designated as a destination. On the other hand, when receiving a signal requesting establishment of connection from the user terminal 100a, the payment terminal 200b determines that the connection establishment request is not addressed to itself because the payment terminal ID 313a is designated in the connection establishment request. Therefore, the payment terminal 200b does not respond to the received connection establishment request.

As described above, in the present example embodiment, since an information code includes a payment terminal ID, even if a plurality of payment terminals exist within the range of the short-range wireless communication of the payment terminal 200a, biometric information can be output to an appropriate payment terminal. Therefore, payment processing based on biometric authentication can be appropriately performed.

### Fifth Example Embodiment

The fifth example embodiment is a modified example of the third or fourth example embodiment described above. An information code according to the fifth example embodiment designates (long-distance) communication via the network N as a communication method, and further includes a store ID. That is, the information code includes destination information of the authentication control apparatus that controls a biometric authentication. Further, the information code may further include identification information of a processing terminal (payment terminal) that performs processing according to the biometric authentication.

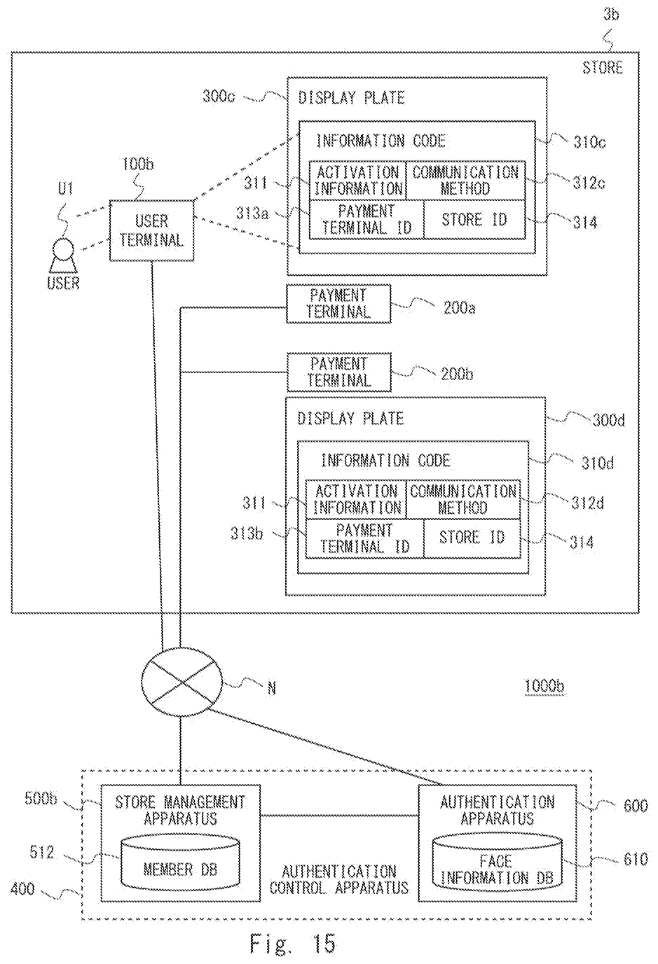

FIG. 15 is a block diagram illustrating an overall configuration of an authentication system 1000b according to the fifth example embodiment. The authentication system 1000b differs from the authentication system 1000a described above in information included in an information code of a display plate installed near each payment terminal in a store 3b. Note that, hereinafter, differences from the above-described fourth example embodiment will be mainly described, and redundant description and illustration will be appropriately omitted.

Specifically, a display plate 300c is installed near the payment terminal 200a. An information code 310c is displayed on the display plate 300c, and the information code 310c includes activation information 311, a communication method 312c, a payment terminal ID 313a, and a store ID 314. In addition, a display plate 300d is installed near the payment terminal 200b. An information code 310d is displayed on the display plate 300d, and the information code 310d includes activation information 311, a communication method 312d, a payment terminal ID 313b, and a store ID 314.

Each of the communication methods 312c and 312d includes designation of communication via the network N and an address or the like of the authentication control apparatus 400 (store management apparatus 500b or authentication apparatus 600) as destination information. The store ID 314 is identification information of the store 3b.

The functions of the user terminal 100b are different from the functions of the user terminals 100 and 100a described above in information code extraction processing and face image output processing. Specifically, the user terminal 100b extracts activation information, a communication method, a payment terminal ID, and a store ID, by analyzing the acquired image of the information code. Further, the user terminal 100b outputs a face image or the like by transmitting the face image or the like to either the store management apparatus 500b or the authentication apparatus 600 (authentication control apparatus 400) via the network N according to the extracted communication method. Further, the user terminal 100b transmits the extracted payment terminal ID and store ID together with the face image or the like.

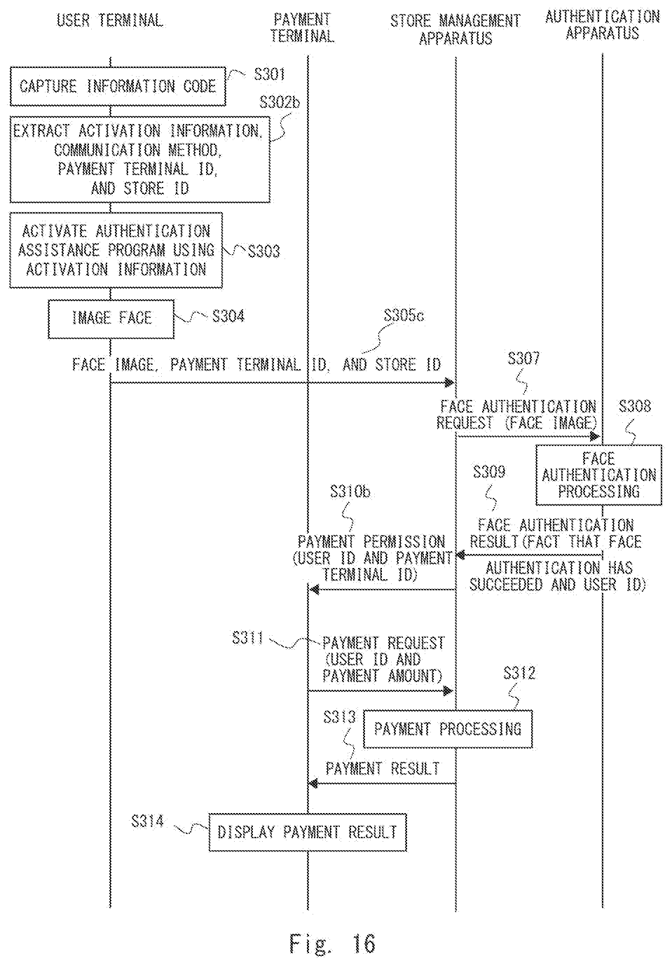

FIG. 16 is a sequence diagram illustrating a flow of payment processing according to the fifth example embodiment. Here, differences from FIG. 14 described above will be mainly described. As a premise, it is assumed that the user terminal 100b exists in front of the display plate 300a and the payment terminal 200a.

First, the user terminal 100b captures an information code 310c displayed on the display plate 300c by the camera 110 (S301). Next, the user terminal 100b extracts activation information 311, a communication method 312c, a payment terminal ID 313a, and a store ID 314, by analyzing the captured information code 310c (S302b). Then, after steps S303 and S304, the user terminal 100b transmits a face image or the like, a payment terminal ID 313a, and a store ID 314 to the store management apparatus 500b via the network N (S305c). For example, the user terminal 100b designates the address of the store management apparatus 500b as a transmission destination.

Accordingly, the store management apparatus 500b receives the face image or the like, the payment terminal ID 313a, and the store ID 314 from the user terminal 100b via the network N. Since the received store ID 314 indicates the store 3b, the store management apparatus 500b performs step S307 as described above. Then, the authentication apparatus 600 performs step S308 as described above, and transmit a face authentication result as a response.

Then, the store management apparatus 500b determines whether the face authentication has succeeded based on the received face authentication result. When the face authentication result indicates that the face authentication has failed, the store management apparatus 500b transmits, to the user terminal 100b via the network N, the fact that the authentication has failed, that is, the fact that it is not allowed to make a payment based on face authentication.

Here, it is assumed that the face authentication result includes the fact that the face authentication has succeeded and the user ID of the user U1. Therefore, the store management apparatus 500b determines that the user U1 has succeeded in the face authentication. The store management apparatus 500b transmits a payment permission including the user ID of the user U1 and the received payment terminal ID 313a (identification information of the payment terminal 200a) to the payment terminal 200a via the network N (S310b).

The payment terminal 200a receives the payment permission from the store management apparatus 500b via the network N. Thereafter, the payment terminal 200a performs the processing of step S311 and the subsequent steps as described above.

As described above, in the present example embodiment, since an information code includes designation of communication via the network as a communication method, a store ID, and a payment terminal ID, the user terminal is capable of performing payment processing based on face authentication without a short-range wireless communication function. In addition, the store management apparatus 500b can notify an appropriate payment terminal of a payment permission by virtue of the store ID and the payment terminal ID.

### Other Example Embodiments

Note that an information code according to another example embodiment may include a uniform resource locator (URL) as a destination information. In this case, it is assumed that the URL includes the address of the server that is a destination where biometric information is registered. It is assumed that the server is connected to the user terminal, the payment terminal, the store management apparatus, and the authentication apparatus via the network N. In addition, the URL may designate a folder or a directory of a destination for registration in the server, a name of an application operating in the server to perform processing of registration and output of biometric information, or the like. In this case, by analyzing the image of the acquired information code, the user terminal extracts activation information, a communication method, and a URL indicating a server that is a destination where biometric information is registered. Note that the information code may include a payment terminal ID and a store ID as described above. Then, the user terminal activates the authentication assistance program using the activation information, images the user's face, uploads a face image to the extracted URL, and registers the face image in the registration destination server.

Thereafter, for example, the user terminal outputs information including the extracted URL to the payment terminal by short-range wireless communication. Accordingly, the payment terminal can download the face image from the acquired URL. Then, the processing of the steps after S306 in FIG. 11 described above is performed. Alternatively, the user terminal may not output information including the extracted URL to the payment terminal. For example, after the user terminal registers the face image in the registration destination server, the registration destination server may transmit a registration completion notification including the URL to the payment terminal or to the payment terminal via the store management apparatus. The payment terminal may download the face image from the URL included in the registration completion notification received from the registration destination server. Then, the processing of the steps after S306 in FIG. 11 described above may be performed. Note that, in this case, the information code may include a payment terminal ID and a store ID together with the URL. Alternatively, the URL included in the information code may be different for each payment terminal.

Alternatively, in a case where the information code includes a payment terminal ID and a store ID together with the URL, the face image is uploaded onto the extracted URL, and the face image is registered in the registration destination server. Then, the user terminal may transmit information including the payment terminal ID and the store ID together with the extracted URL to the store management apparatus via the network N. Accordingly, the store management apparatus can download the face image, the payment terminal ID, and the store ID from the acquired URL. Then, the processing of the steps after S307 in FIG. 16 described above is performed. Further, the user terminal may transmit information including the payment terminal ID and the store ID together with the extracted URL to the authentication apparatus via the network N. Accordingly, the authentication apparatus can download the face image, the payment terminal ID, and the store ID from the acquired URL. Then, the authentication apparatus performs face authentication processing, and transmits a face authentication result, the payment terminal ID, and the store ID to the store management apparatus. Then, the processing of the steps after S310b in FIG. 16 described above is performed.

Alternatively, the user terminal may upload the payment terminal ID and the store ID together with the face image onto the extracted URL, and register the face image, the payment terminal ID, and the store ID in association with each other in the registration destination server. In this case, the registration destination server transmits a face authentication request including the face image to the authentication apparatus, and receives a face authentication result. When the face authentication has succeeded, the registration destination server may notify the payment terminal of the face authentication result, with the payment terminal ID associated with the face image that has succeeded in the face authentication as a destination. Then, the processing of the steps after S311 in FIG. 11 described above is performed. Alternatively, when the face authentication has succeeded, the registration destination server may notify the store management apparatus of the face authentication result and the payment terminal ID, with the store ID associated with the face image that has succeeded in the face authentication as a destination. Then, the processing of the steps after S310 in FIG. 11 described above is performed.

As described above, it can be said that even in a case where the information code includes a URL for a destination where biometric information is registered, the user terminal outputs the biometric information of the user for biometric authentication by registering the biometric information of the user in the URL.

Furthermore, in the fourth or fifth example embodiment described above, the information code may include a different URL for each payment terminal. For example, it is assumed that the information code 310a corresponding to the payment terminal 200a includes a URL (X), and the information code 310b corresponding to the payment terminal 200b includes a URL (Y). In this case, it is assumed that the URL (X) is set in advance in the payment terminal 200a for access at the time of payment, and the URL (Y) is set in advance in the payment terminal 200b for access at the time of payment. Then, for example, in a case where the information code 310a is captured and analyzed, the user terminal extracts the URL (X) and uploads the face image onto the URL (X). The payment terminal 200a can download the face image from the URL (X) at the time of payment without a notification of the URL (X) from the user terminal. Then, the processing of the steps after S306 in FIG. 11 described above is performed.

Note that, in the above-described example embodiment, the user terminal 100 activates the camera by reading an information code as a trigger, captures a face image, and outputting the face image or the like to assists a face authentication. Then, in the above-described example embodiment, terminal information of the user terminal 100 and user information (user ID or the like) may be registered in advance in association with each other in the authentication control apparatus 400. In that case, the user terminal 100 transmits terminal information of itself together with a face image to the authentication control apparatus 400 via the payment terminal 200 or to the authentication control apparatus 400 directly. Then, the authentication control apparatus 400 may perform settlement processing when a user ID corresponding to the received terminal information matches a user ID specified by the face authentication. As a result, two-factor authentication, including an authentication of the user based on terminal information that is a source from which a face image is output and a biometric authentication based on biometric information (face image or the like), is achieved, thereby improving authentication accuracy. Note that the terminal information of the user terminal 100 and the user information (user ID or the like) may be registered in association with each other in a customer management system on a cloud connected to the authentication control apparatus 400, instead of the authentication control apparatus 400.

Note that, in the third or fourth example embodiment described above, the store management apparatus 500 and the authentication apparatus 600 have been described as separate information processing apparatuses, but may be the same apparatus. For example, the store management apparatus 500 may further register facial feature information in association with the user ID 5121 of the member DB 512. In this case, the control unit 540 only needs to further include the functions of the face detection unit 620, the feature point extraction unit 630, the registration unit 640, and the authentication unit 650 shown in FIG. 7. Similarly, the store management apparatus 500b according to the fifth example embodiment described above may be the same information processing apparatus.

In the above-described example, the program includes a group of instructions (or software codes) for causing a computer to perform one or more of the functions described in the example embodiments when read by the computer. The program may be stored in a non-transitory computer readable medium or a tangible storage medium. As an example and not by way of limitation, the computer readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage devices. The program may be transmitted on a transitory computer readable medium or a communication medium. As an example and not by way of limitation, the transitory computer readable medium or the communication medium includes propagated signals in electrical, optical, acoustic, or any other form.

Note that the present disclosure is not limited to the above-described example embodiments, and can be appropriately changed without departing from the scope. In addition, the present disclosure may be implemented by appropriately combining the example embodiments.

Some or all of the above-described example embodiments may be described as the following supplementary notes, but are not limited to the following.

### Supplementary Note A1

A user terminal including:
an imaging means for capturing an information code including predetermined activation information;
an activation means for activating an authentication assistance function using the activation information included in the captured information code;
an acquisition means for acquiring an image including a face of a user captured by the imaging means according to the activation of the authentication assistance function; and
an output means for outputting biometric information of the user based on the image for biometric authentication.

### Supplementary Note A2

The user terminal according to supplementary note A1, in which
the information code includes designation of a communication method for the biometric information, and
the output means outputs the biometric information according to the communication method designated by the information code.

### Supplementary Note A3

The user terminal according to supplementary note A2, in which the communication method is short-range wireless communication.

### Supplementary Note A4

The user terminal according to any one of supplementary notes A1 to A3, in which
the information code includes terminal information that is a destination to which the biometric information is output, and
the output means outputs the biometric information with the terminal information included in the information code as an output destination.

### Supplementary Note A5

The user terminal according to supplementary note A1 or A2, in which
the information code includes destination information of an authentication control apparatus configured to control the biometric authentication, and
the output means outputs the biometric information by transmitting the biometric information to the destination information included in the information code.

### Supplementary Note A6

The user terminal according to supplementary note A5, in which
the information code further includes identification information of a processing terminal configured to perform processing according to the biometric authentication, and
the output means outputs the biometric information and the identification information of the processing terminal included in the information code by transmitting the biometric information and the identification information of the processing terminal to the destination information.

### Supplementary Note A7

The user terminal according to any one of supplementary notes A1 to A6, in which
the biometric authentication is face authentication, and
the biometric information is facial feature information.

### Supplementary Note B1

A processing execution apparatus including:
an acquisition means for acquiring, from a user terminal possessed by a user, biometric information based on an image including a face of the user captured by the user terminal according to an authentication assistance function of the user terminal activated based on predetermined activation information included in an information code captured by the user terminal;
an authentication control means for controlling biometric authentication for the user when the biometric information is acquired; and
an execution means for executing predetermined processing when the biometric authentication has succeeded.

### Supplementary Note B2

The processing execution apparatus according to supplementary note B1, in which the acquisition means acquires the biometric information from the user terminal by short-range wireless communication.

### Supplementary Note B3

The processing execution apparatus according to supplementary note B1 or B2, in which
the biometric authentication is face authentication, and
the biometric information is facial feature information.

### Supplementary Note C1

An authentication system including:
a user terminal possessed by a user; and
a processing execution apparatus configured to execute predetermined processing, in which
the user terminal includes:
an imaging means for capturing an information code including predetermined activation information;
an activation means for activating an authentication assistance function using the activation information included in the captured information code;
an acquisition means for acquiring an image including a face of the user captured by the imaging means according to the activation of the authentication assistance function; and
an output means for outputting biometric information of the user based on the image for biometric authentication, and
the processing execution apparatus includes:
an acquisition means for acquiring the biometric information from the user terminal;
an authentication control means for controlling biometric authentication for the user when the biometric information is acquired; and
an execution means for executing predetermined processing when the biometric authentication has succeeded.

### Supplementary Note C2

The authentication system according to supplementary note C1, in which
the information code includes designation of a communication method for the biometric information, and
the output means outputs the biometric information according to the communication method designated by the information code.

### Supplementary Note D1

An authentication assistance method including:
by a computer including an imaging device,
capturing an information code including predetermined activation information by the imaging device;
activating an authentication assistance function using the activation information included in the captured information code;
acquiring an image including a face of a user captured by the imaging device according to the activation of the authentication assistance function; and
outputting biometric information of the user based on the image for biometric authentication.

### Supplementary Note E1

A non-transitory computer readable medium storing a program for causing a computer including an imaging device to execute:
imaging processing of capturing an information code including predetermined activation information by the imaging device;
activation processing of activating an authentication assistance function using the activation information included in the captured information code;
acquisition processing of acquiring an image including a face of a user captured by the imaging device according to the activation of the authentication assistance function; and
output processing of outputting biometric information of the user based on the image for biometric authentication.

### Supplementary Note F1

A processing execution method including:
by a computer:
acquiring, from a user terminal possessed by a user, biometric information based on an image including a face of the user captured by the user terminal according to an authentication assistance function of the user terminal activated based on predetermined activation information included in an information code captured by the user terminal;
controlling biometric authentication for the user when the biometric information is acquired; and
executing predetermined processing when the biometric authentication has succeeded.

### Supplementary Note G1

A non-transitory computer readable medium storing a program for causing a computer to execute:
acquisition processing of acquiring, from a user terminal possessed by a user, biometric information based on an image including a face of the user captured by the user terminal according to an authentication assistance function of the user terminal activated based on predetermined activation information included in an information code captured by the user terminal;
authentication control processing of controlling biometric authentication for the user when the biometric information is acquired; and
execution processing of executing predetermined processing when the biometric authentication has succeeded.

Although the present invention has been described with reference to the example embodiments (and examples), the present invention is not limited to the above-described example embodiments (and examples). Various changes that can be understood by those skilled in the art can be made to the configurations and details of the present invention within the scope of the present invention.

### REFERENCE SIGNS LIST

1 USER TERMINAL
11 IMAGING UNIT
12 ACTIVATION UNIT
13 ACQUISITION UNIT
14 OUTPUT UNIT
2 PROCESSING EXECUTION APPARATUS
21 ACQUISITION UNIT
22 AUTHENTICATION CONTROL UNIT
23 EXECUTION UNIT
1000 AUTHENTICATION SYSTEM
U1 USER
N NETWORK
100 USER TERMINAL
100a USER TERMINAL
100b USER TERMINAL
110 CAMERA
120 STORAGE UNIT
121 CONTROL PROGRAM
122 AUTHENTICATION ASSISTANCE PROGRAM
130 MEMORY
140 COMMUNICATION UNIT
150 INPUT/OUTPUT UNIT
160 CONTROL UNIT
161 IMAGING CONTROL UNIT
162 ACQUISITION UNIT
163 REGISTRATION UNIT
164 EXTRACTION UNIT
165 ACTIVATION UNIT
166 OUTPUT UNIT
200 PAYMENT TERMINAL
220 STORAGE UNIT
221 PROGRAM
222 STORE ID
223 PAYMENT TERMINAL ID
230 MEMORY
240 COMMUNICATION UNIT
250 INPUT/OUTPUT UNIT
260 CONTROL UNIT
261 ACQUISITION UNIT
262 AUTHENTICATION CONTROL UNIT
263 PAYMENT UNIT
3 STORE
300 DISPLAY PLATE
310 INFORMATION CODE
311 ACTIVATION INFORMATION
312 COMMUNICATION METHOD
1000a AUTHENTICATION SYSTEM
200a PAYMENT TERMINAL
200b PAYMENT TERMINAL
3a STORE
300a DISPLAY PLATE
310a INFORMATION CODE
313a PAYMENT TERMINAL ID
300b DISPLAY PLATE
310b INFORMATION CODE
313b PAYMENT TERMINAL ID
1000b AUTHENTICATION SYSTEM
3b STORE
300c DISPLAY PLATE
310c INFORMATION CODE
312c COMMUNICATION METHOD
314 STORE ID
300d DISPLAY PLATE
310d INFORMATION CODE
312d COMMUNICATION METHOD
400 AUTHENTICATION CONTROL APPARATUS
500 STORE MANAGEMENT APPARATUS
500b STORE MANAGEMENT APPARATUS
510 STORAGE UNIT
511 PROGRAM
512 MEMBER DB
5121 USER ID
5122 PERSONAL INFORMATION
5123 PAYMENT INFORMATION
520 MEMORY
530 COMMUNICATION UNIT
540 CONTROL UNIT
541 REGISTRATION UNIT
542 AUTHENTICATION CONTROL UNIT
543 PAYMENT PROCESSING UNIT
600 AUTHENTICATION APPARATUS
610 FACE INFORMATION DB
611 USER ID
612 FACIAL FEATURE INFORMATION
620 FACE DETECTION UNIT
630 FEATURE POINT EXTRACTION UNIT
640 REGISTRATION UNIT
650 AUTHENTICATION UNIT

What is claimed is:

1. A user terminal comprising:
an imaging device;
at least one storage device configured to store instructions; and
at least one processor configured to execute the instructions to:
capture an information code including predetermined activation information using the imaging device;
activate an authentication assistance function using the activation information included in the captured information code;
acquire an image including a face of a user captured by the imaging device according to the activation of the authentication assistance function; and
output biometric information of the user based on the image for biometric authentication.

2. The user terminal according to claim 1, wherein
the information code includes designation of a communication method for the biometric information, and
wherein the at least one processor is further configured to execute the instructions to:
output the biometric information according to the communication method designated by the information code.

3. The user terminal according to claim 2, wherein the communication method is short-range wireless communication.

4. The user terminal according to claim 1, wherein
the information code includes terminal information that is a destination to which the biometric information is output, and
wherein the at least one processor is further configured to execute the instructions to:
output the biometric information with the terminal information included in the information code as an output destination.

5. The user terminal according to claim 1, wherein
the information code includes destination information of an authentication control apparatus configured to control the biometric authentication, and
wherein the at least one processor is further configured to execute the instructions to:
output the biometric information by transmitting the biometric information to the destination information included in the information code.

6. The user terminal according to claim 5, wherein
the information code further includes identification information of a processing terminal configured to perform processing according to the biometric authentication, and
wherein the at least one processor is further configured to execute the instructions to:
output the biometric information and the identification information of the processing terminal included in the information code by transmitting the biometric information and the identification information of the processing terminal to the destination information.

7. The user terminal according to claim 1, wherein
the biometric authentication is face authentication, and
the biometric information is facial feature information.

8. A processing execution apparatus comprising:
at least one storage device configured to store instructions; and
at least one processor configured to execute the instructions to:
acquire, from a user terminal possessed by a user, biometric information based on an image including a face of the user captured by the user terminal according to an authentication assistance function of the user terminal activated based on predetermined activation information included in an information code captured by the user terminal;
control biometric authentication for the user when the biometric information is acquired; and
execute predetermined processing when the biometric authentication has succeeded.

9. The processing execution apparatus according to claim 8,
wherein the at least one processor is further configured to execute the instructions to:
acquire the biometric information from the user terminal by short-range wireless communication.

10. The processing execution apparatus according to claim 8, wherein
the biometric authentication is face authentication, and
the biometric information is facial feature information.

11. An authentication system comprising:
a user terminal possessed by a user; and
a processing execution apparatus configured to execute predetermined processing, wherein
the user terminal includes:
an imaging device;
at least one first storage device configured to store first instructions; and
at least one first processor configured to execute the first instructions to:
capture an information code including predetermined activation information using the imaging device;
activate an authentication assistance function using the activation information included in the captured information code;
acquire an image including a face of the user captured by the imaging device according to the activation of the authentication assistance function; and
output biometric information of the user based on the image for biometric authentication, and
the processing execution apparatus includes:
at least one second storage device configured to store second instructions; and
at least one second processor configured to execute the second instructions to:
acquire the biometric information from the user terminal;
control biometric authentication for the user when the biometric information is acquired; and
execute predetermined processing when the biometric authentication has succeeded.

12. The authentication system according to claim 11, wherein
the information code includes designation of a communication method for the biometric information, and
wherein the at least one first processor is further configured to execute the first instructions to:
output the biometric information according to the communication method designated by the information code.

13. An authentication assistance method comprising:
by a computer including an imaging device,
capturing an information code including predetermined activation information by the imaging device;
activating an authentication assistance function using the activation information included in the captured information code;
acquiring an image including a face of a user captured by the imaging device according to the activation of the authentication assistance function; and
outputting biometric information of the user based on the image for biometric authentication.

14. A non-transitory computer readable medium storing a program for causing a computer including an imaging device to execute:
imaging processing of capturing an information code including predetermined activation information by the imaging device;
activation processing of activating an authentication assistance function using the activation information included in the captured information code;
acquisition processing of acquiring an image including a face of a user captured by the imaging device according to the activation of the authentication assistance function; and
output processing of outputting biometric information of the user based on the image for biometric authentication.

15. A processing execution method comprising:
by a computer:
acquiring, from a user terminal possessed by a user, biometric information based on an image including a face of the user captured by the user terminal according to an authentication assistance function of the user terminal activated based on predetermined activation information included in an information code captured by the user terminal;
controlling biometric authentication for the user when the biometric information is acquired; and
executing predetermined processing when the biometric authentication has succeeded.

16. A non-transitory computer readable medium storing a program for causing a computer to execute:
acquisition processing of acquiring, from a user terminal possessed by a user, biometric information based on an image including a face of the user captured by the user terminal according to an authentication assistance function of the user terminal activated based on predetermined activation information included in an information code captured by the user terminal;
authentication control processing of controlling biometric authentication for the user when the biometric information is acquired; and
execution processing of executing predetermined processing when the biometric authentication has succeeded.
